(19) United States
(12) Patent Application Publication
(10) Pub. No.: US 2007/0047489 A1
(43) Pub. Date: Mar. 1, 2007

(54) Handoffs in wireless communications network incorporating voice over IP using shared supplemental spreading codes

(76) Inventors: Rainer Walter Bachl, Nuremberg (DE); Jens Mueckenheim, Nuremberg (DE); Anil M. Rao, Cedar Knolls, NJ (US); Mirko Schacht, Nuremberg (DE)

Correspondence Address: Lucent Technologies Inc.;Docket Administrator, Room 3J-219, 101 Crawfords Corner Road, Holmdel, NJ, 07733-3030, US

(21) Appl. No.: 11/213,383

(22) Filed: Aug. 26, 2005

(51) Int. Cl. H04Q 7/00

(52) U.S. Cl. 370/331

(57) ABSTRACT

Disclosed is a method and system for performing handoffs in a wireless communications network which incorporates Voice over Internet Protocol (VoIP) using shared supplemental spreading codes. In this method and system, a mobile station is assigned a first and second primary code and a first and second set of supplemental codes. The first primary and set of supplemental codes are associated with a first base station. The second primary and set of supplemental codes are associated with a second base station and assigned to the mobile station when the mobile station is entering into a handoff state. The first and second set of supplemental codes belong to a pool of shared supplemental codes associated with the first and second base stations, respectively. A specific supplemental code is assigned from each of the first and second sets of supplemental codes when a complete packet cannot be transmitted over a single transmission time interval on the first and second primary channels. Each of the specific supplemental codes must be currently available before it could be assigned. Mapping tables may be used to associate assigned specific supplemental code indicators to specific supplemental codes belonging to the first and second set of supplemental codes. The mapping tables may be Transport Combination Format (TFC) mapping tables, and the assigned specific supplemental code indicators may be Transport Combination Format Indicators (TFCI). A single TFCI or equivalent may be used to indicate a same or different supplemental code at each of the first and second base stations.

### RELATED APPLICATION

Related subject matter is disclosed in the following application filed concurrently and assigned to the same assignee hereof: U.S. patent application Ser. No. ______ entitled, “Wireless Communications Network Incorporating Voice Over IP Using Shared Supplemental Spreading Codes,” inventor Jens Mueckenheim, Anil Rao and Mirko Schacht.

### FIELD OF THE INVENTION

The present invention relates generally to Internet Protocol applications and, in particular, to handoffs in a wireless communication system.

### BACKGROUND

Incorporating Voice over Internet Protocol (VoIP) service into wireless communications networks, such as wireless communications networks based on the well-known third generation Universal Mobile Telecommunications System (UMTS) technology, simplifies core network design and adds new and valuable services compared to traditional circuit switch (CS) voice. However, VoIP also inherently adds additional overhead in the form of large headers and signaling, thereby reducing system capacity.

In related application entitled “Wireless Communications Network Incorporating Voice Over IP Using Shared Supplemental Spreading Codes” by Jens Mueckenheim, Anil Rao and Mirko Schacht and being filed concurrently, disclosed is a concept for sharing supplemental spreading codes in order to minimize the adverse effects of VoIP on system capacity. However, this concept does not provide procedures for handling soft handoffs. Accordingly, there exists a need for a set of soft handoff procedures for use in a wireless communications network incorporating VoIP using shared supplemental spreading codes.

### SUMMARY OF THE INVENTION

The present invention is a method and system for performing handoffs in a wireless communications network. In one embodiment, the wireless communications network incorporates Voice over Internet Protocol (VoIP) using shared supplemental spreading codes. In this embodiment, a mobile station is assigned a first and second primary code and a first and second set of supplemental codes. The first primary and set of supplemental codes are associated with a first base station. The second primary and set of supplemental codes are associated with a second base station and assigned to the mobile station when the mobile station is entering into a handoff state. The first and second set of supplemental codes belong to a pool of shared supplemental codes associated with the first and second base stations, respectively. A specific supplemental code is assigned from each of the first and second sets of supplemental codes when a complete packet cannot be transmitted over a single transmission time interval on the first and second primary channels. Each of the specific supplemental codes must be currently available before it could be assigned.

In other embodiments, mapping tables are used to associate assigned specific supplemental code indicators to specific supplemental codes belonging to the first and second set of supplemental codes. The mapping tables may be Transport Combination Format (TFC) mapping tables, and the assigned specific supplemental code indicators may be Transport Combination Format Indicators (TFCI). In an embodiment, a single TFCI or equivalent may be used to indicate a same or different supplemental code at each of the first and second base stations.

### BRIEF DESCRIPTION OF THE DRAWINGS

The features, aspects, and advantages of the present invention will become better understood with regard to the following description, appended claims, and accompanying drawings where:

FIG. 1 depicts a Universal Mobile Telecommunications System (UMTS) based wireless communications system, the internet and a Voice over Internet Protocol (VoIP) phone in accordance with the present invention;

FIG. 2 depicts a protocol stack used for a VoIP call between the VoIP phone and a User Equipment (UE) in accordance with the UMTS based wireless communications network of the present invention;

FIG. 3 depicts a flowchart illustrating call set-up procedures for implementing VoIP service over a downlink Dedicated CHannel (DCH) using a shared pool of supplemental channels in accordance with the present invention;

FIG. 4 depicts a flowchart illustrating an in-progress VoIP call over a downlink DCH in accordance with the present invention; and

FIG. 5 depicts a flowchart illustrating a set of handoff procedures in accordance with the present invention.

### DETAILED DESCRIPTION

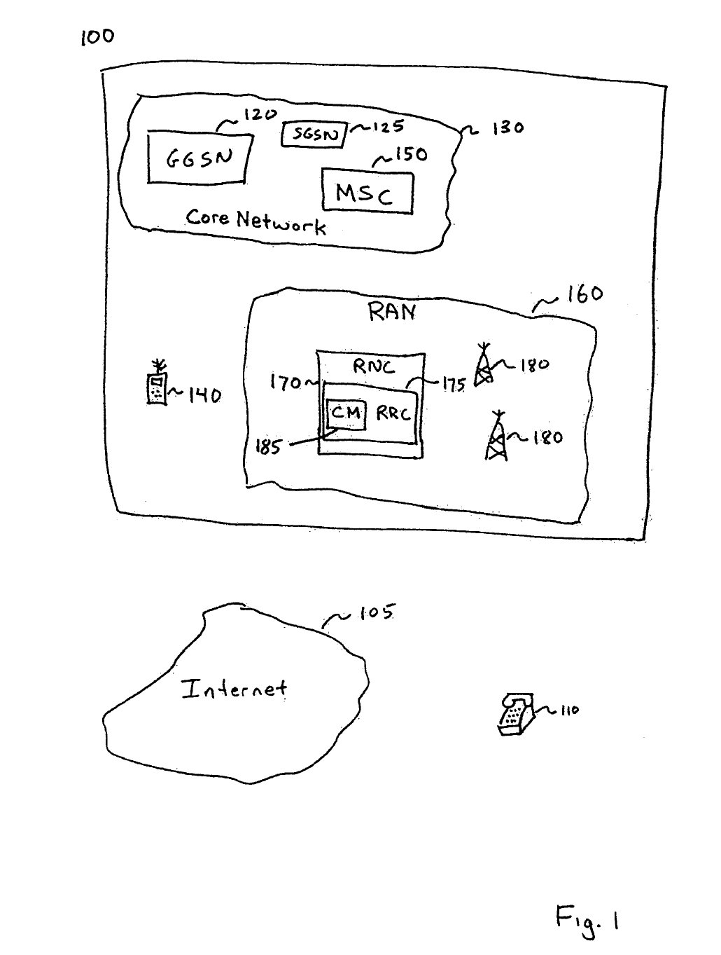

The present invention is a method and system thereof for soft handoffs in a wireless communications network incorporating Voice over Internet Protocol (VoIP) using shared supplemental spreading codes. To fully describe soft handoffs of the present invention, the wireless communications network and procedures for handling VoIP call set-up and in-progress VoIP calls need to be described first. FIG. 1 depicts a Universal Mobile Telecommunications System (UMTS) based wireless communications system 100, internet 105 and a VoIP phone 110 in accordance with the present invention. Wireless communications system 100 comprises at least core network 130, Radio Access Network (RAN) 160, and User Equipment (UE) or mobile station 140. The core network 130 includes Gateway GPRS Support Node (GGSN) 120, Serving GPRS Support Node (SGSN) 125 and Mobile Switching Center (MSC) 150. GGSN 120 is an interface between internet 105 and core network 130, while SGSN 125 is an interface between core network 130 and RAN 160. The Radio Access Network (RAN) 160 includes one or more Radio Network Controller (RNC) 170 and one or more Node B (or base station) 180. RNC 170 includes a Radio Resource Control (RRC) 175. RRC 175 having functionalities for managing radio resources, including Code Manager (CM) 185. CM 185 include functionalities for managing Orthogonal Variable Spreading Factor (OVSF) codes for each Node B 180 connected to RNC 170.

Communication channels between Node B and UE 140 are configured using a multitude of Orthogonal Variable Spreading Factor (OVSF) codes. For VoIP calls, CM 185 assigns an OVSF code to UE 140 for configuring a downlink Dedicated CHannel (DCH). The DCH and OVSF codes being used to configure the DCH are also referred to herein as a “primary channel” and a “primary OVSF code”, respectively. In UMTS, the DCH includes a Dedicated Physical Data CHannel (DPDCH) and a Dedicated Physical Control CHannel (DPCCH).

Depending on the capabilities of UE 140, CM 185 may also assign a set of N OVSF codes to UE 140 for configuring a set of N supplemental channels in accordance with multi-code techniques in UMTS, where N is some integer greater or equal to one. In one embodiment, the supplemental channel may comprise only of a DPDCH. In another embodiment, the supplemental channel may comprise only of a DPDCH and a DPCCH. In yet another embodiment, the supplemental channel may comprise of at least a DPDCH and, possibly, a DPCCH. Note that hereinafter the term “supplemental OVSF codes” will be used to refer to OVSF codes that support supplemental channels. In a preferred embodiment, the primary and supplemental OVSF codes have the same SF, such as 128.

Basically, if UE 140 is capable of simultaneously supporting, e.g., decoding, two or more DPDCHs, then CM 185 can assign a set of N supplemental OVSF codes to UE 140. Such a UE is referred to herein as a “multi-code UE”. Otherwise, if UE 140 is not a multi-code UE, then CM 185 does not assign any supplemental OVSF codes to UE 140.

The set of N supplemental OVSF codes assigned to UE 140 are selected from a set of M supplemental OVSF codes, wherein M is greater than or equal to N. The set of M supplemental OVSF codes being a set of OVSF codes reserved by CM 185 at Node B 180, and being associated with a shared pool of supplemental channels (or OVSF codes) at Node B 180. Note that, in accordance with the present invention, there will be a set of M supplemental OVSF codes reserved by CM 185 for each Node B. The supplemental OVSF codes reserved at one Node B may include some, all or none of the supplemental OVSF codes reserved at another Node B. In a preferred embodiment, the parameter M should be chosen to balance between minimizing excessive supplemental OVSF code reservation and the possibility that more than M supplemental OVSF codes may be simultaneously required. The parameter M may be static or dynamically determined depending on system metrics such as load, supplemental OVSF code usage, etc. The parameter N should be chosen based on a variety of factors, such as keeping Transport Format Combination Set (TFCS) a reasonable size, limiting UE complexity, and the capabilities of UE. In one embodiment, the parameter N is set equal to 3 for multi-code UEs capable of 384 kbps, 768 kbps and 2048 kbps data rates.

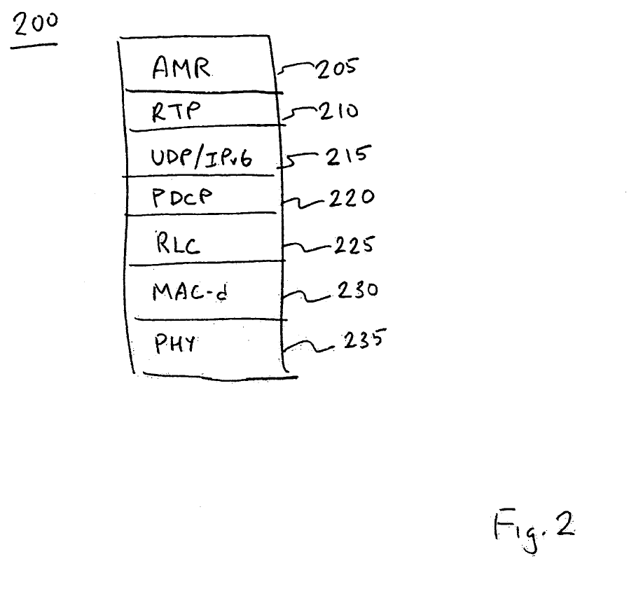

Processing a VoIP call over a wireless communications network requires the use of a protocol stack. FIG. 2 depicts a protocol stack 200 used for a VoIP call between VoIP phone 110 and UE 140 used in accordance with UMTS based wireless communications network 100. The VoIP call being processed in the PS domain of UMTS-based wireless communications system 100. In some system deployments, VoIP phone 110 may be an electronic device that converts a Public Switched Telephone Network (PSTN) call into a VoIP call. In other deployments, the PSTN or wireless communications network may have an Inter-Working Function (IWF) or Media GateWay (MGW) that converts a PSTN call into a VoIP call. As shown in FIG. 2, protocol stack 200 includes an Adaptive Multi-Rate (AMR) layer 205, a Real Time Protocol (RTP) layer 210, a User Datagram Protocol/Internet Protocol version 6 or another version of Internet Protocol, such as version 4 (UDP/IPv6) layer 215, a Packet Data Convergence Protocol (PDCP) layer 220, a Radio Link Control (RLC) layer 225, a dedicated Medium Access Control (MAC-d) layer 230 and a PHYsical (PHY) layer 235. AMR layer 205, RTP layer 210 and UDP/IPv6 layer 215 being implemented at VoIP phone 110. PDCP layer 220, RLC layer 225 and Mac-d layer 230 being implemented at RNC 170. And PHY layer 235 being implemented at Node B 180. Note that although UDP/IPv6 layer 215 is being shown as a single layer, its actual implementation would probably be as two separate UDP and IPv6 layers.

For illustration purposes, suppose speech information is being sent from VoIP phone 110 to UE 140. At VoIP phone 110, speech is encoded in AMR layer 205 (via an AMR codec) to produce a speech frame having 159 speech bits. In RTP layer 210, a RTP payload is formed by adding to one or more speech frames a 4 bit Codec Mode Request (CMR) field, a 6 bit Table Of Contents (TOC) field for each speech frame in the RTP payload, and padding bits for purposes of octet alignment. For an AMR 7.95 kbps codec with 159 speech bits, there are 7 padding bits added to the RTP payload. A RTP packet is formed by adding a 12 byte RTP header to the RTP payload for conveying information such as RTP sequence number, time stamp, M and X fields, synchronization source ID, etc.

In UDP/IPv6 layer 215, an 8 byte UDP header and a 40 byte IP header are added to the RTP packet to produce a UDP/IPv6 packet. The UDP header indicating source/destination port numbers and a UDP checksum, and the IP header indicating the source/destination IP addresses. Thus, over 60 bytes of overhead in the form of headers and other information are added by the RTP and UDP/IPv6 layers 210, 215 to the original 159 bit speech frame resulting in an bit size increase of over 300%.

The UDP/IPv6 packet is sent from VoIP phone 110 through internet 105 to GGSN 120. From GGSN 120, the UDP/IPv6 packet is forwarded to SGSN 125 and then to RAN 160. Fortunately, once the UDP/IPv6 packet reaches RAN 160, it is no longer necessary to transmit the complete RTP/UDP/IPv6 header for each speech packet over an air interface because much of the information conveyed in the RTP/UDP/IPv6 header is static. After the intended receiver, e.g., UE 140, has acquired all the static information in the RTP/UDP/IPv6 header, the RTP/UDP/IPv6 header can be compressed in PDCP layer 220 using Robust Header Compression (ROHC) to form a PDCP packet comprising of the RTP payload and a compressed header. The compressed header containing dynamic information in the RTP/UDP/IPv6 header, such as the RTP sequence number, time stamp, M and X fields, and UDP checksum. In most situations, the RTP/UDP/IPv6 header can be compressed into 3 bytes. Specifically, the RTP header can be compressed down to 1 byte for indicating the 6 least significant bits (LSB) of the sequence number. The UDP header can be compressed down to 2 bytes corresponding to the UDP checksum. In other situations, the compressed header cannot be compressed down into 3 bytes because some of the lesser dynamic information in the RTP/UDP/IPv6 header would need to be updated at the receiver, for example, during resynchronization or at the beginning of talk spurts. Note that, in the latter situations, it is possible that the RTP/UDP/IPv6 header is not compressed at all. When the RTP/UDP/IPv6 header is not compressed, then the PDCP packet would comprise of the RTP payload and the uncompressed RTP/UDP/IPv6 header. Thus, the PDCP packet will include a representation of the RTP/UDP/IPv6 header which may be anywhere between 3 to 60 bytes. Such fluctuation in the RTP/UDP/IPv6 header representation leads to significant data rate variations.

In RLC layer 225, a 1 byte RLC UM header is added to the PDCP packet to produce an RLC packet, wherein the RLC UM header includes a RLC sequence number. The RLC packet is subsequently processed in MAC-d layer 230 and PHY layer 235 before being transmitted via Node B to UE 140 over an air interface.

In addition to overhead being added via headers, signaling associated with VoIP is also added. VoIP requires additional signaling such as Real Time Control Protocol (RTCP) and the Session Initiation Protocol (SIP). This additional signaling can result in the multiplexing of up to four transport channels (including the downlink DCH over which the speech frame is transmitted): a first transport channel for Signaling Radio Bearer (SRB); a second transport channel for carrying speech, i.e., DCH; a third transport channel for RTCP; and a fourth transport channel for SIP. Each of these channels are associated with multiple data rates. SRB being associated with data rates of 0 and 3.4 kbps. Speech being associated with data rates of 0, 16 and 39.2 kbps (where the 39.2 kbps data rate corresponds to a packet with uncompressed RTP/UDP/IPv6 header). And RTCP and SIP being associated with data rates of 0, 8 and 16 kbps. The activity on each of these channels can lead to significant data rate variations.

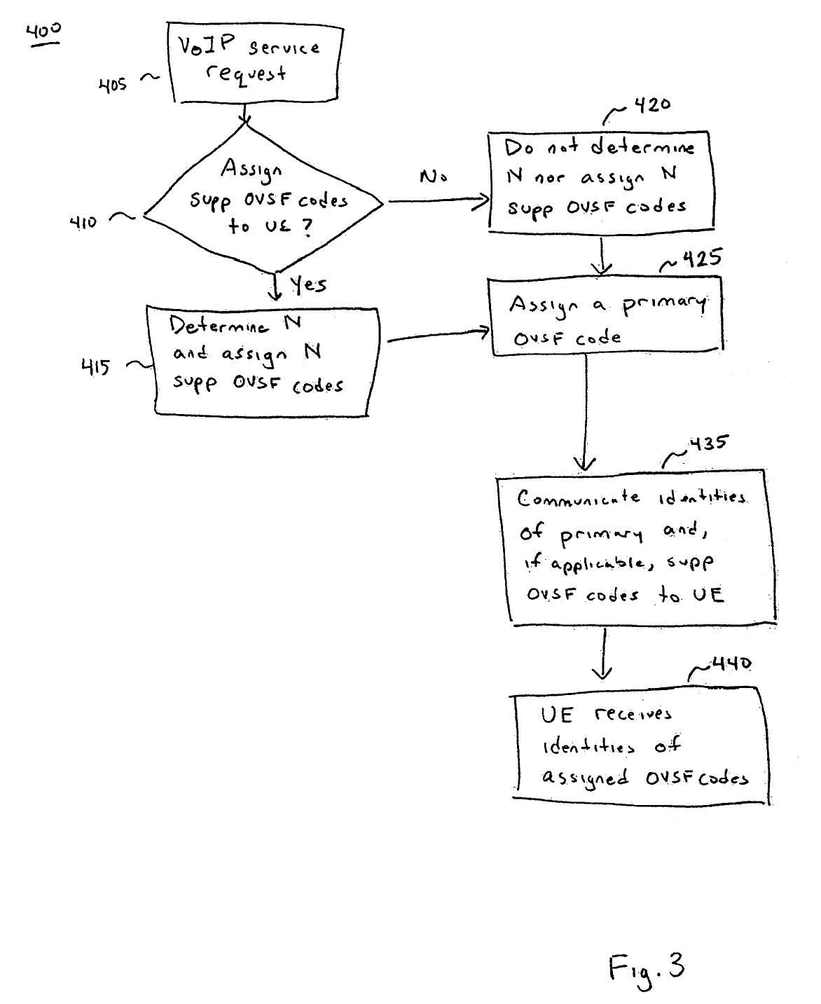

Because of variations in data rate due to fluctuations in overhead in the form of headers and signaling, the present invention utilizes a shared supplemental code concept in the wireless communications network such that system resources can be more efficiently utilized, as will be described herein. FIG. 3 depicts a flowchart 400 illustrating call set-up procedures for implementing Voice over Internet Protocol (VoIP) service over a downlink DCH using a shared pool of supplemental channels in accordance with the present invention. In step 405, VoIP service is being requested for UE 140. In step 410, RRC 175 determines whether supplemental OVSF codes are to be assigned to UE 140 based on the capabilities of UE 140. Basically, if UE 140 is a multi-code UE, then RRC 175 determines supplemental OVSF codes are to be assigned to UE 140. If it is determined that supplemental OVSF codes are not to be assigned to UE 140, then in step 420 RRC 175 does not determine a value for the parameter N nor does CM 185 assign any supplemental OVSF codes to UE 140. From step 420, flowchart 400 proceeds to step 425 where CM 185 assigns a primary OVSF code to UE 140.

On the other hand, if supplemental OVSF codes are to be assigned to UE 140, then in step 415 RRC 175 determines a value for the parameter N and CM 185 assigns N supplemental OVSF codes to UE 140. The N supplemental OVSF codes being selected from the set of M supplemental OVSF codes. From step 415, flowchart 400 continues to step 425 where CM 185 assigns a primary OVSF code to UE 140. In step 435, RNC 170 communicates via Node B 180 the identities of the assigned primary OVSF code and, if applicable, the identities of the N supplemental OVSF codes to UE 140 over a Dedicated Control Channel (DCCH) or similar downlink control channel. In step 440, UE 140 receives the identities of the primary and supplemental OVSF codes (if applicable). UE 140 will now begin to store the data being received over primary and supplemental channels, i.e., the multiple DPDCHs, configured with the primary and supplemental OVSF codes. UE 140 will decode the data on the primary channel. If UE 140 is a multi-code UE and was assigned supplemental OVSF codes, UE 140 will not decode the data on any of the associated supplemental channels unless it receives some type of indication to decode a specific supplemental channel, as will be described herein.

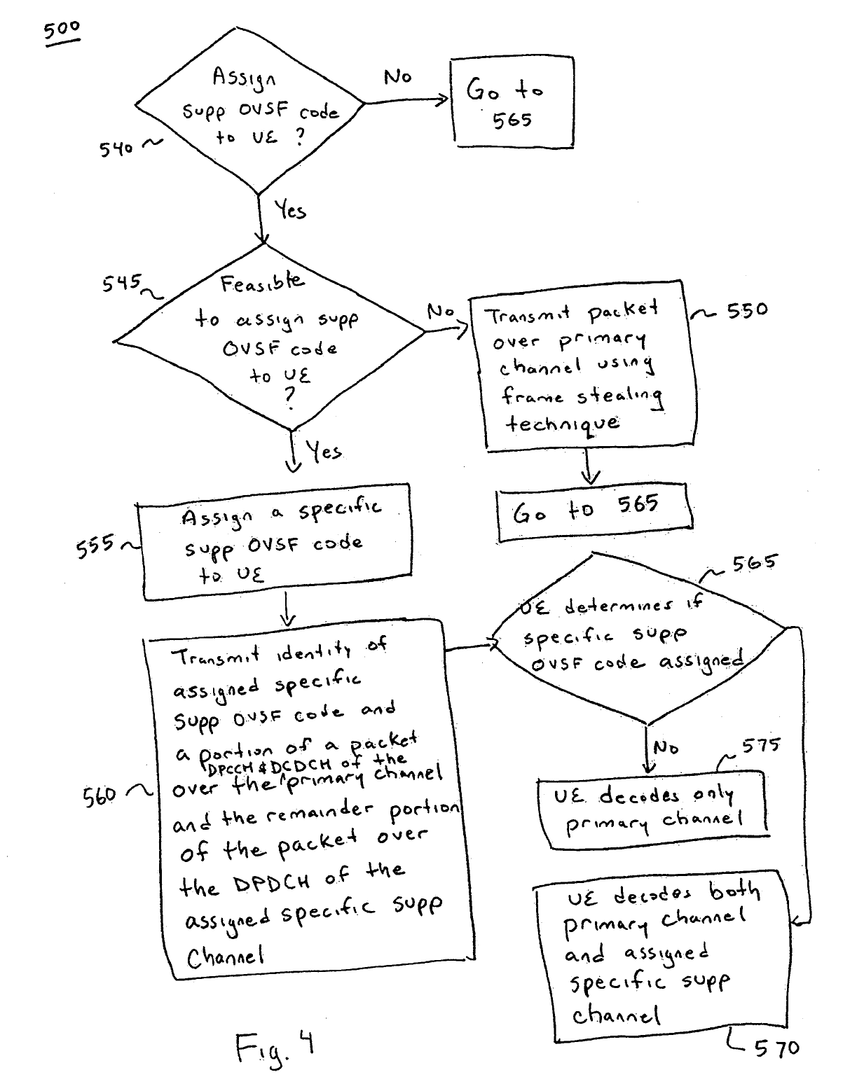

After call set-up is completed, UE is ready to receive VoIP calls. FIG. 4 depicts a flowchart 500 illustrating an in-progress VoIP call over a downlink DCH in accordance with the present invention. In step 540, RNC 170 receives a packet from RAN 160 and determines whether a supplemental channel should be used, in addition to the primary channel, for the transmission of the packet to UE 140. Basically, a supplemental channel should not be used if the packet includes one of these combinations: speech, compressed RTP/UDP/IPv6 header and SRB; SIP and SRB; or RTCP and SRB. A supplemental channel should be used if the packet includes one of these combinations: speech, uncompressed RTP/UDP/IPv6 and SRB; or speech, compressed RTP/UDP/IPv6 header, SRB and SIP. In one embodiment, determining whether a supplemental channel should be used is based on the size of the packet. More specifically, a supplemental channel should be used if the packet cannot be transmitted over the DCH in a single Transmission Time Interval (TTI), e.g., 20 ms. If it is determined that a supplemental channel should not be used for the packet transmission, then flowchart 500 continues to step 565.

If it is determined that a supplemental channel should be used for the packet transmission, then in step 545 CM 185 determines whether it would be feasible to assign a supplemental OVSF code to UE 140. In one embodiment, if a set of N supplemental OVSF codes had been assigned to UE 140, CM 185 checks to see if any of those supplemental OVSF codes are currently available, i.e., not currently being used by another UE. If a set of N supplemental OVSF codes had not been assigned to UE 140 or if none of the assigned N supplemental OVSF codes are currently available, then it is determined that it would not be feasible to assign a supplemental OVSF code to UE 140 and flowchart 500 continues to step 550. In step 550, a well-known technique referred to as frame stealing is used by RNC 170 to transmit the packet (after it has been further processed in subsequent protocol layers) via Node B to UE 140 over the primary channel only. As is well-known, frame stealing is a technique which blanks out speech frames and sends the control information (which is a part of the overhead information) in its place. Frame stealing will result in lost speech frames which may adversely affect speech quality. From step 550, flowchart 500 continues to step 565.

If, on the other hand, it is determined that it would be feasible to assign a supplemental channel to UE 140, flowchart 500 continues to step 555 where CM 185 assigns a specific supplemental OVSF code from the assigned set of N supplemental OVSF codes. Upon assigning the specific supplemental OVSF code, in step 560, RNC 170 transmits via Node B a portion of the packet (after it has been further processed in subsequent protocol layers) and the identity of the assigned specific supplemental OVSF code (or an indication of the supplemental OVSF code or supplemental channel associated therewith) over the DPDCH and DPCCH of the primary channel, respectively, and another portion of the packet (after it has been further processed in subsequent protocol layers) over the DPDCH of a supplemental channel configured with the specific supplemental OVSF code. Preferably, the identity of the assigned specific supplemental OVSF code and both portions of the packet are sent concurrently. In other embodiments, the identity of the assigned specific supplemental OVSF code may be sent earlier or later than both portions of the packet.

In one embodiment, the identity of the specific supplemental OVSF code is conveyed using Transport Format Combination Index (TFCI) field on the DPCCH of the DCH. Note that the TFCI usually only indicates a frame size, e.g., 300 bits. In this embodiment of the present invention, the TFCI will indicate both a frame size and, if applicable, an assigned specific supplemental OVSF code. For example, a TFCI of 1 might indicate a frame size of 300 bits and no assigned specific supplemental OVSF code, whereas a TFCI of 4 might indicate a frame size of 600 bits and the assigned specific supplemental OVSF code from the set of assigned N supplemental OVSF codes. The assigned specific supplemental OVSF code may be indicated by its relative position in the set of N supplemental OVSF codes, e.g., first supplemental OVSF code in the set of N supplemental OVSF codes, or indicated by referencing its unique identity, e.g., supplemental OVSF code 67. A TFCI mapping table may be provided to UE 140 during call set-up to indicate to the mapping for the TFCI. That is, when UE 140 receives a TFCI, it will reference the TFC mapping table to determine the appropriate TFC and, if applicable, supplemental OVSF code. The TFC mapping table being a lookup table or similar for, at least, a TFCI to frame size and supplemental OVSF code, if applicable.

Flowchart 500 continues to step 565. In step 565, assuming UE 140 is a multi-code UE, UE 140 decodes the control information on the DPCCH of the primary channel to determine whether one of the supplemental OVSF codes (from the set of N supplemental OVSF codes) has been assigned to it. In one embodiment, if the identity of a supplemental OVSF code has been indicated in the control information, then UE 140 will determine that the supplemental OVSF code indicated in the control information has been assigned to it. Otherwise, UE 140 will determine that no supplemental OVSF code has been assigned to it.

Note that UE 140 will always decode the data on the DPDCH of the primary channel. If the control information indicates the identity of a specific supplemental OVSF code (or supplemental channel) being used to send data, then UE 140 also decodes the data on the DPDCH on the identified supplemental channel and discards the data on the other supplemental channels. If the control information indicates that data exists only on the primary channel, UE 140 discards the data on all supplemental channels.

If UE determines that a supplemental OVSF code has been assigned to it, then flowchart 500 continues to step 570 where UE 140 will decode the data on the DPDCH of the assigned supplemental channel in addition to decoding the data on the DPDCH of its primary channel. Otherwise, flowchart 500 continues to step 575 where UE 140 will decode data on the DPDCH of its primary channel but not on the DPDCH of any of its assigned set of N supplemental channels.

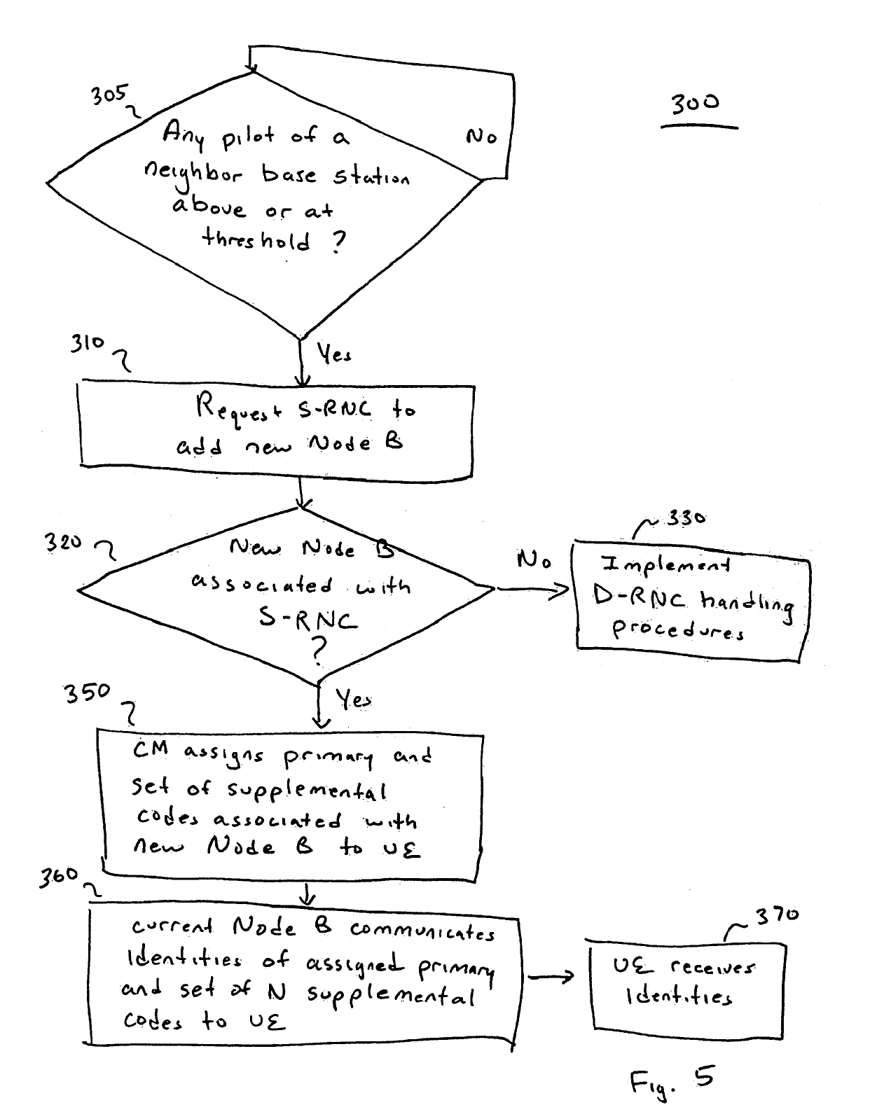

When the VoIP call is in-progress, UE 140 may move from a coverage area of one Node B 180 (also referred to herein as “current Node B”) to a coverage area of another Node B 180 (also referred to herein as “new Node B”). In such a situation, a handoff from the current Node B to the new Node B needs to occur such that UE 140 does not drop the VoIP call. FIG. 5 depicts a flowchart 300 illustrating a set of handoff procedures in accordance with the present invention. In step 305, UE 140 monitors pilot signal strengths from a set of Node Bs referred to herein as a “neighbor set” to determine if any of the neighbor set Node Bs are associated with a pilot signal strength at or above a threshold level. With respect to the present invention pilot signal strength is equivalent to any quality measure on a CDMA system, such as the pilot signal to noise ratio or the pilot received signal level. If such a neighbor set Node B does not exist, UE 140 continues monitoring pilot signal strengths in step 305. If such a neighbor set Node B exists, then in step 310 UE 140 requests the RNC associated with the current Node B (also referred to herein as a “serving RNC” or “S-RNC”) to add a new Node B (i.e., neighbor set Node B associated with pilot signal strength at or above threshold level) to its active set. Typically, such request is sent over a reverse link control channel, i.e., reverse link DCCH, to the current Node B which, in turn, forwards it to the S-RNC.

Note that this process of adding of a new Node B to the active set (and increasing the number of base stations in an active set from one to two) is known as entering a handoff state. Once the new Node B has been added to the active set, the UE is then in the handoff state.

In step 310, S-RNC (or CM 185) receives the request and determines whether the new Node B is associated with it or another RNC 170 referred to herein as a “drifting RNC” or “D-RNC”, which owns a separate code manager for the NodeBs under D-RNC control that cannot be controlled by S-RNC. If the new Node B is associated with a D-RNC, then flowchart 300 continues to step 315 where procedures for handling D-RNC situations are implemented. Some options for handling D-RNC situations are as follow: The first option involves avoiding soft handoff of UE 140 from the current Node B to the new Node B. UE 140 will maintain its radio link with the current Node B until the radio link quality with the new Node B is better. When such an event occurs, a hard handoff is performed from the current Node B to the new Node B. The second option is to perform Serving Radio Network Subsystem (SRNS) relocation. In SRNS relocation, the connection between the S-RNC and the core network (hereinafter referred to as “Iu connection”) is relocated to the D-RNC. This second option can be combined with the first option, i.e., hard handoff combined with SRNS relocation.

The third option involves restricting UE 140 to a primary OVSF code. In this option, supplemental OVSF code allocation can no longer be implemented and techniques such as frame stealing would be implemented when the situation calls for it, e.g., situation which would trigger a need for a supplemental channel. The last option involves assigning no supplemental OVSF code to UE 140.

If, in step 310, the new Node B is associated with the S-RNC (and not a D-RNC), then flowchart 300 continues to step 350 where CM 185 assigns a primary code for the new Node B and, if needed, changes the set of N supplemental OVSF codes currently assigned to UE 140 to a new set of N supplemental OVSF codes. In one embodiment referred to herein as the “intersecting set embodiment”, if the set of N supplemental OVSF codes currently assigned to UE 140 are not part of the shared pool of M supplemental OVSF codes associated with the new Node B, then a new set of N supplemental OVSF codes for the current Node B will be assigned to UE 140 by CM 185. This new set of N supplemental OVSF codes being selected from a set of shared supplemental OVSF codes common to the current Node B and new Node B. In other words, the current and new Node Bs are each associated with a shared pool of supplemental OVSF codes. Some or all of the supplemental OVSF codes associated with the current Node B are also associated with the new Node B. These common supplemental OVSF codes are also referred to herein as a “intersecting set”, and the new set of N supplemental OVSF codes is also referred to herein as an “intersecting set of N supplemental OVSF codes”. The intersecting set may be the same, in whole or part, across all Node Bs associated with a same RNC or different RNCs. Since the supplemental OVSF codes in the intersecting set of N supplemental OVSF codes are common to both Node Bs, a same TFC mapping table may be used to associated a TFCI with an assigned specific supplemental OVSF code.

In another embodiment, a set of N supplemental OVSF codes are assigned to UE 140 for the new Node B. In this embodiment, referred to herein as the “combination set embodiment”, the sets of N supplemental OVSF codes associated with the new Node B and the current Node B most likely include different supplemental OVSF codes. Separate TFC mapping tables associated with each of the Node Bs are sent to UE 140 each time a set of N supplemental OVSF codes is assigned such as during call set-up of the current and new Node Bs. Note that a TFCI will probably refer to different specific supplemental OVSF codes at different Node Bs.

In yet another embodiment, each supplemental OVSF code is associated with a class, wherein a class designates when a supplemental OVSF code may be assigned. For example, suppose there are four classes of supplemental OVSF codes. The first class of supplemental OVSF codes can only be assigned to UEs with one radio link, i.e., not in soft handoff. The second class of supplemental OVSF codes can only be assigned to UEs with two radio links, i.e., in soft handoff with only two Node Bs. Similarly, the third and fourth classes of supplemental OVSF codes can only be assigned to UEs with three and four radio links, respectively. During initial call set-up (prior to soft handoff), UE 140 is assigned a set of N supplemental OVSF codes belonging to the first class. When UE 140 enters into a soft handoff with a new Node B, then CM 185 assigns a set of N supplemental OVSF codes belonging to the second class for both the current and new Node Bs (while replacing the current Node B's initial assigned set of N supplemental OVSF codes belonging to the first class). The supplemental OVSF codes in the set of N supplemental OVSF codes associated with both Node Bs may or may not be completely or partially identical. TFC mapping tables associated with each of the Node Bs are sent to UE 140 each time a set of N supplemental OVSF codes is assigned.

Returning to flowchart 300, in step 355, the current Node B communicates the identities of the new Node B primary OVSF code and intersecting set of N supplemental OVSF codes to UE 140 over the DCCH. In step 360, UE 140 receives the aforementioned identities and sets up a primary channel with the new Node B using the received primary OVSF code (while maintaining the primary channel configured with the current Node B's primary OVSF code). UE 140 will also start storing data received on supplemental channels configured with the intersecting set of N supplemental OVSF codes from the current Node B and the new Node B. Once the primary and supplemental channels associated with the new Node B have been set-up, the VoIP call between UE 140 and each Node B is handled in accordance with the procedures for in-progress VoIP calls described herein with respect to flowchart 500.

With respect to the intersecting set embodiment, it should be noted that if a supplemental channel is needed (as described in steps 540 to 555 in FIG. 4), CM 185 assigns the same specific supplemental OVSF code from the intersecting set of N supplemental OVSF codes for both Node Bs. Since the same specific supplemental OVSF code is being assigned, the identity of the assigned specific supplemental OVSF code can be indicated using the same indicator or identity. That is, instead of sending an indication of the assigned specific supplemental OVSF code for the current Node B and a separate indication of the assigned specific supplemental OVSF code for the new Node B, one indication may be used for both. Note that although the new Node B has already been added to UE's active set (and is no longer considered a neighbor set Node B), the term “new Node B” will continue to be used herein to distinguish it from the “current Node B”, i.e., Node B which was and currently is in the active set prior to the new Node B.

The identity of this assigned specific supplemental OVSF code (or indication thereof) is signaled over the DPCCHs of both primary channels associated with the current and new Node Bs in accordance with step 560. Advantageously, signaling the indication of the assigned specific supplemental OVSF code over the DPCCHs of both primary channels allows for soft combining of the indication sent on the DPCCHs, thereby the exploiting macro diversity gain implicit in soft handoff. By contrast, if a different specific supplemental OVSF code was assigned to each of the Node Bs, then separate indications (of the identities of both supplemental OVSF codes) would need to be sent to UE 140. Since the indications would be different, then there can be no soft combining of the DPCCHs.

With respect to the combination set embodiment, when a supplemental channel is needed, CM 185 will first check that the specific supplemental OVSF codes being referred to by a single TFCI are all currently available before assigning any specific supplemental OVSF code. That is, the TFCI can refer to a specific supplemental OVSF code based on the TFC mapping table associated with the current Node B and to a different specific supplemental OVSF code based on the TFC mapping table associated with the new Node B. Since two different supplemental OVSF codes can be referred to with a single TFCI, then CM 185 needs to check that all the specific supplemental OVSF codes at their respective Node Bs (referred to by a single TFCI) are currently available before making any specific supplemental OVSF code assignment. Upon assignment, the TFCI is transmitted over the DPCCHs of both primary channels.

With respect to the tiered set embodiment, when a supplemental channel is needed, CM 185 will also check that the specific supplemental OVSF codes being referred to by a single TFCI are all currently available before assigning any specific supplemental OVSF code. Upon assignment, the TFCI is transmitted over the DPCCHs of both primary channels.

Although the present invention has been described in considerable detail with reference to certain embodiments, other versions are possible. For example, the sequence of the steps in flowcharts 400 and 500 may be different. Codecs other than AMR may be used. Data applications other than VoIP may be used. Also note that the embodiments were described herein with respect to soft handoffs in which there are two Node Bs, it should be obvious to one of ordinary skill in the art how to apply the teachings herein to soft handoffs involving three or more Node Bs. Therefore, the spirit and scope of the present invention should not be limited to the description of the embodiments contained herein.

1. A method of performing handoffs in a wireless communications network comprising the steps of:
assigning to a mobile station a first primary code and a first set of supplemental codes associated with a first base station, the first set of supplemental codes belonging to a first pool of shared supplemental codes associated with the first base station; and
assigning to the mobile station a second primary code and a second set of supplemental codes associated with a second base station after the mobile station receives a signal transmitted from the second base station with a signal strength measurement above a threshold value, the second set of supplemental codes belonging to a second pool of shared supplemental codes associated with the second base station.

2. The method of claim 1 comprising the additional steps of:
assigning a first and a second assigned specific supplemental code to the mobile station, the first assigned specific supplemental code belonging to the first set of supplemental codes, the second assigned specific supplemental code belonging to the second set of supplemental codes; and
transmitting over a first primary channel a first assigned specific supplemental code indicator to the mobile station for indicating an identity of the first assigned specific supplemental code, the first primary channel being configured with the first primary code; and
transmitting over a second primary channel a second assigned specific supplemental code indicator to the mobile station for indicating an identity of the second assigned specific supplemental code, the second primary channel being configured with the second primary code, the first and second assigned specific supplemental code indicator may or may not be identical.

3. The method of claim 2 comprising the additional steps of:
transmitting from the first base station a first portion of a packet over the first primary channel and a second portion of the packet over a first assigned specific supplemental channel, the first assigned specific supplemental channel configured with the first assigned specific supplemental code; and
transmitting from the second base station the first portion of the packet over the second primary channel and the second portion of the packet over a second assigned specific supplemental channel, the second assigned specific supplemental channel configured with the second assigned specific supplemental code.

4. The method of claim 2, wherein the step of assigning the first and second assigned specific supplemental codes includes a determination that the first and second assigned specific supplemental codes are currently available at the first and second base stations, respectively.

5. The method of claim 2 comprising the additional steps of:
prior to the step of transmitting the first and second assigned specific supplemental code indicators, transmitting a first and a second mapping table for associating the first and second assigned specific supplemental code indicators to a first and a second assigned specific supplemental code belonging to the first and second sets of supplemental codes, respectively.

6. The method of claim 5 wherein the first and second assigned specific supplemental code indicators are identical and can indicate a same or different supplemental code using the first and second mapping tables.

7. The method of claim 5, wherein the first and second mapping tables are Transport Combination Format (TFC) mapping tables and the first and second supplemental code indicators are Transport Combination Format Indices (TFCI).

8. The method of claim 2 comprising the additional step of:
prior to the step of assigning the first and second assigned specific supplemental codes, determining whether a packet to be transmitted can be transmitted over a single transmission time interval over a primary channel.

9. The method of claim 1, wherein the first and second sets of supplemental codes belong to a class of supplemental codes reserved at the first and second base stations, respectively, for use in handoffs.

10. The method of claim 1, wherein the wireless communications network is based on the well-known Universal Mobile Telecommunications System (UMTS) and is providing Voice over Internet Protocol (VoIP) services to the mobile station, the method further comprising the steps of:
transmitting over a first control channel a first primary code indication for indicating the identity of the first primary code and one or more first supplemental code indications for indicating the identity of the first set of supplemental codes; and
transmitting over a second control channel a second primary code indication for indicating the identity of the second primary code and one or more second supplemental code indications for indicating the identity of the second set of supplemental codes, wherein the first and second control channels may be a same or different control channel.

11. A method of performing handoffs in a wireless communications network comprising the steps of:
receiving a first primary code indicator and a first set of supplemental code indicators associated with a first base station, the first primary code and first set of supplemental code indicators indicating identities of a first primary code and a first set of supplemental codes, respectively, the first set of supplemental codes belonging to a first pool of shared supplemental codes associated with the first base station;
transmitting an indication that a signal strength measurement associated with a second base station is over a threshold value; and
receiving a second primary code indicator and a second set of supplemental code indicators associated with the second base station, the second primary code and second set of supplemental code indicators indicating identities of a second primary code and a second set of supplemental codes, respectively, the second set of supplemental codes belonging to a second pool of shared supplemental codes associated with the second base station.

12. The method of claim 11 comprising the additional step of:
receiving over a first and a second primary channel a first and a second assigned specific supplemental code indicator for indicating an identity of a first and a second assigned specific supplemental code, the first and second assigned specific supplemental codes belonging to the first and second set of supplemental codes, the first and second primary channels being configured using the first and second primary codes, respectively.

13. The method of claim 12 comprising the additional step of:
decoding a first and a second supplemental channel after receiving the first and second assigned specific supplemental code indicators, the first and second supplemental channels being configured using the first and second assigned specific supplemental codes, respectively.

14. The method of claim 12, wherein prior to receiving the first and second assigned specific supplemental code indicators, not decoding any of supplemental channels configured using any supplemental code belonging to either the first or second set of assigned supplemental codes.

15. The method of claim 12 comprising the additional step of:
prior to receiving the first and second assigned specific supplemental code indicators, receiving a first and a second mapping table for associating the first and second assigned specific supplemental code indicators to a first and a second assigned specific supplemental code belonging to the first and second sets of supplemental codes, respectively.

16. The method of claim 15, wherein the first and second mapping tables are Transport Combination Format (TFC) mapping tables and the first and second supplemental code indicators are Transport Combination Format Indices (TFCI).

17. The method of claim 15 wherein the first and second assigned specific supplemental code indicators are identical and can indicate a same or different supplemental code using the first and second mapping tables.

18. The method of claim 12 comprising the additional steps of:
receiving from the first base station a first portion of a packet over the first primary channel and a second portion of the packet over a first assigned specific supplemental channel, the first assigned specific supplemental channel configured with the first assigned specific supplemental code; and
receiving from the second base station the first portion of the packet over the second primary channel and the second portion of the packet over a second assigned specific supplemental channel, the second assigned specific supplemental channel configured with the second assigned specific supplemental code.

19. A wireless communications network comprising:
a code manager for managing code allocation including assignments of a first primary code and a first set of supplemental codes associated with a first base station and assignments of a second primary code and a second set of supplemental codes associated with a second base station after the mobile station receives a signal transmitted from the second base station with a signal strength measurement above a threshold value, the first set of supplemental codes belonging to a first pool of shared supplemental codes associated with the first base station, the second set of supplemental codes belonging to a second pool of shared supplemental codes associated with the second base station;
the first base station for transmitting a first portion of a packet over a first primary channel and a second portion of the packet over a first assigned specific supplemental channel, the first primary and assigned specific supplemental channels configured with the first primary and assigned specific supplemental codes, respectively; and
the second base station for transmitting the first portion of the packet over the second primary channel and the second portion of the packet over a second assigned specific supplemental channel, the second primary and assigned specific supplemental channels configured with the second primary and assigned specific supplemental codes, respectively.

20. A mobile station comprising:
a receiver for receiving a first primary code indicator and a first set of supplemental code indicators associated with a first base station and for receiving a second primary code indicator and a second set of supplemental code indicators associated with the second base station, wherein the first primary code and first set of supplemental code indicators indicate identities of a first primary code and a first set of supplemental codes, respectively, the first set of supplemental codes belonging to a first pool of shared supplemental codes associated with the first base station, the second primary code and second set of supplemental code indicators indicating identities of a second primary code and a second set of supplemental codes, respectively, the second set of supplemental codes belonging to a second pool of shared supplemental codes associated with the second base station; and
means for decoding a first and a second supplemental channel configured using a first and a second assigned specific supplemental code, wherein the first and second assigned specific supplemental codes belonging to the first and second sets of supplemental codes, respectively,
the means for decoding being operable to decode the first and second supplemental channels after the receiver receives a first and a second assigned specific supplemental code indicator, the first and second assigned specific supplemental code indicators indicating an identity of the first and second assigned specific supplemental code, respectively.
